(19) United States
(12) Patent Application Publication
(10) Pub. No.: US 2007/0216075 A1
(43) Pub. Date: Sep. 20, 2007

(54) FLUID-FILLED VIBRATION DAMPING DEVICE AND SEAL STRUCTURE FOR AIR CHAMBER IN THE SAME

(75) Inventor: Yuichi Ogawa, Kasugai-Shi (JP)

Correspondence Address: BURR & BROWN, PO BOX 7068, SYRACUSE, NY, 13261-7068, US

(73) Assignee: Tokai Rubber Industries, Ltd., Komaki-Shi (JP)

(21) Appl. No.: 11/626,533

(22) Filed: Jan. 24, 2007

(30) Foreign Application Priority Data
Mar. 20, 2006 (JP) 2006-075795

(51) Int. Cl. F16F 13/00

(52) U.S. Cl. 267/140.12

(57) ABSTRACT

A construction of a fluid-filled vibration damping device provided with an air chamber for applying an air pressure capable of increasing the pressure of a fluid in a fluid chamber is realized advantageously in industry. An air chamber is formed between a cylindrical member and a bottom member forming a second mounting member, and a seal protrusion that is caused to fall easily to the inside of the air chamber is interposed between these elements. In the state in which the air chamber is formed, the cylindrical member and the bottom member are brought close to each other and lapped on each other, by which the volume of the air chamber is decreased by an amount corresponding to the approach amount of the elements and the volume amount of the seal protrusion entering into the air chamber due to falling, and thereby the internal pressure of the air chamber is increased.

This application is based on Japanese Patent Application No. 2006-075795 filed Mar. 20, 2006, the contents of which are incorporated hereinto by reference.

### BACKGROUND OF THE INVENTION

1. Field of the Invention

The present invention relates to a fluid-filled vibration damping device and a seal structure for an air chamber in the fluid-filled vibration damping device. More particularly, it relates to an improved structure of a fluid-filled vibration damping device that has a plurality of fluid chambers filled with a non-compressible fluid so as to exhibit a damping effect on the basis of flows of a fluid between the fluid chambers, and an advantageous seal structure for an air chamber, formed in such a fluid-filled vibration damping device to improve the vibration damping property.

2. Description of the Related Art

A fluid-filled vibration damping device configured as described below has been known conventionally. As one kind of a vibration damping connector or a vibration damping support interposed between members forming a vibration transmission system, a first and a second mounting members, which are spaced apart from each other, are connected to each other by an elastic rubber body interposed therebetween, and on the first mounting member side, a part of a wall portion is formed by the elastic rubber body with a partition member supported on the second mounting member being held therebetween, by which a pressure-receiving chamber filled with a predetermined non-compressible fluid, in which fluctuations in internal pressure take place when vibrations are applied, is formed. Meanwhile, on the opposite side to the pressure-receiving chamber, a part of the wall portion is formed by a flexible diaphragm, by which an equilibrium chamber filled with a predetermined non-compressible fluid, in which a change in volume is allowed due to the deformation of the flexible diaphragm, is formed. Further, an orifice passage is provided to allow the pressure-receiving chamber and the equilibrium chamber to communicate with each other.

In the fluid-filled vibration damping device having the above-described construction, a profound vibration damping effect, which cannot be achieved by an elastic rubber body only, can be achieved easily due to the flow action of non-compressible fluid caused to flow in the orifice passage by the change in internal pressure in the pressure-receiving chamber at the time when vibrations are applied. Therefore, the fluid-filled vibration damping device of this type is used advantageously as an engine mount, a body mount, and a differential mount for a motor vehicle, and the like.

For the motor vehicle and the like using the above-described fluid-filled vibration damping device, if a shock-like high vibration load is applied, for example, when the vehicle gets over a height difference etc., in the fluid-filled vibration damping device, a phenomenon called cavitation takes place, so that abnormal noise and vibrations that can be perceived by the passenger sometimes occur. It is presumed that the mechanism of generating noise and vibrations is as described below. If a shock-like high vibration load is applied, and in particular, the volume in the pressure-receiving chamber is increased suddenly by great elastic deformation of the elastic rubber body in the direction such that the first mounting member separates from the second mounting member, and thus the interior of the pressure-receiving chamber suddenly becomes in a negative pressure state, air bubbles or a vacuum portion like air bubbles (hereinafter referred generally to as air bubbles) occurs in the fluid filled in the pressure-receiving chamber, and the air bubbles grow to some size and then collapse. At this time, an explosive minute jet flow is formed, and this jet flow is propagated to the first and the second mounting members as a water hammer pressure, and further is propagated to the body and interior parts of motor vehicle, where the water hammer pressure is amplified, by which abnormal noise and vibrations that can be perceived by the passenger are produced.

Under these circumstances, in JP-A-8-170683, the applicant of the present invention has proposed a fluid-filled vibration damping device in which measures against the occurrence of abnormal noise and vibrations caused by cavitation is taken. In this fluid-filled vibration damping device, an air chamber filled with air with a pressure higher than the atmospheric pressure is formed on the opposite side to the equilibrium chamber with the flexible diaphragm being held therebetween. The air pressure in the air chamber is applied to the fluid in the pressure-receiving chamber and the equilibrium chamber via the flexible diaphragm, by which the fluid is pressurized in advance. Thereby, even if the elastic rubber body is elastically deformed greatly in the direction such that the first mounting member separates from the second mounting member when a shock-like high vibration load is applied, the interior of the pressure-receiving chamber is prevented as far as possible from becoming in a negative state. Therefore, the formation of air bubbles in the fluid filled in the pressure-receiving chamber and hence the occurrence of noise and vibrations caused by the collapse of the air bubbles can be alleviated or prevented.

The inventors et al. made studies from various angles on the construction of the conventional fluid-filled vibration damping device. As a result, the fact that some points to be improved exist has been clarified.

In the above-described conventional fluid-filled vibration damping device, the second mounting member has a cylindrical member and a bottomed cylindrical member (in JP-A-8-170683, referred to as a second mounting member). By fixing the cylindrical member in the bottomed cylindrical member under pressure, an integral assembly of the cylindrical member and the bottomed cylindrical member is formed. The pressing of the cylindrical member into the bottomed cylindrical member is performed in a state in which the air chamber is enclosed so that air cannot go in from the outside and go out to the outside, by which the volume of the air chamber is decreased corresponding to the press-in stroke, and thus the internal pressure is increased.

Therefore, in the above-described conventional vibration damping device, in order to perform the reliable pressing under pressure of the cylindrical member into the bottomed cylindrical member, a strict dimensional accuracy is required for both of these members. Also, a portion in which both of the members are lapped on each other in the direction perpendicular to the press-in direction, having a length corresponding to the press-in allowance of each member, exists inevitably on the assembly in which the cylindrical member is assembled by pressing into the bottomed cylindrical member. Therefore, the dimension in the press-in direction of the assembly, namely, the dimension in the axial direction of the second mounting member increases inevitably, which is one cause for hindering the decrease in size of the whole of the vibration damping device.

### SUMMARY OF THE INVENTION

The present invention has been made in view of the above-described circumstances, and accordingly a first object of the present invention is to provide a fluid-filled vibration damping device provided with an air chamber for applying an air pressure capable of pressurizing to a non-compressible fluid filled in a pressure-receiving chamber and an equilibrium chamber, the apparatus having a novel construction that can achieve easy manufacture in which strict dimensional accuracy is not required and small size of the whole of the apparatus. Also, a second object of the invention is to provide an advantageous seal structure for the air chamber in the above-described fluid-filled vibration damping device.

The above first object may be achieved according to the principle of the present invention, which provides a fluid-filled vibration damping device comprising: a first and a second mounting members which are spaced apart from each other; an elastic rubber body which elastically connects the first and second mounting members; a partition member supported by the second mounting member and cooperating with the elastic rubber body to define a pressure-receiving chamber which is filled with a non-compressible fluid and in which an internal pressure is changed by receiving an input vibrational load; a flexible diaphragm cooperating with the partition member to define an equilibrium chamber on one of the opposite sides of the partition member remote from the pressure-receiving chamber, the equilibrium chamber being filled with the fluid, and the flexible diaphragm being displaceable to permit a change in volume of the equilibrium chamber; an orifice passage provided to allow the pressure-receiving chamber and the equilibrium chamber to communicate with each other; and an air chamber filled with air with a pressure higher than an atmospheric pressure, formed on the opposite side to the equilibrium chamber with the flexible diaphragm held between the air chamber and the equilibrium chamber, and an air pressure in the air chamber being applied to the fluid in the equilibrium chamber, whereby the pressure of the fluid may be increased, wherein the second mounting member comprises: (a) a cylindrical member located at the first mounting member side, and having a cylindrical shape; and (b) a bottom member located at the opposite side to the first mounting member, the bottom member being fixed to the cylindrical member and cooperating with the cylindrical member to support the partition member and the flexible diaphragm and forming the air chamber between the flexible diaphragm and the bottom member in a state of being lapped on of the cylindrical member so as to cover an opening on the opposite side to the first mounting member in the cylindrical member; and wherein the device further comprises: (c) a seal member formed of an elastic material, the seal member being interposed between the lapped portions of the cylindrical member and the bottom member in a compressedly deformed state to seal the lapped portion in a fluid-tight manner; and (d) a first seal protrusion formed by a part or a whole of the seal member, having a chevron shape, projecting in the direction such that the cylindrical member and the bottom member are lapped on each other, extending continuously in a circumferential direction so as to surround the air chamber, and being configured so that a cross-sectional shape has an inside surface facing to the air chamber and an outside surface opposite to the inside surface, and an internal angle of the inside surface being larger than the internal angle of the outside surface so that the first seal protrusion easily falls to the air chamber side at the time of compressed deformation caused by lapping of the bottom member on the cylindrical member; and wherein the seal member is interposed between the cylindrical member and the bottom member, either one of the cylindrical member and the bottom member is brought into contact with a tip end portion of the first seal protrusion, and from a state in which the air chamber, the air therein being incapable of going in from an outside and going out to the outside, is formed between the bottom member and the flexible diaphragm, the cylindrical member and the bottom member are brought close to each other and lapped on each other, and the first seal protrusion is caused to fall to an inside of the air chamber in a state of being compressedly deformed, whereby a volume of the air chamber is decreased, so that an internal pressure is increased.

The internal angle of the inside surface and the internal angle of the outside surface of the first seal protrusion in the present invention mean angles formed between the inside and outside surfaces and the plane perpendicular to the projecting direction of the first seal protrusion on the mutually facing side. Hereinafter, these terms are used in the same meaning.

In the fluid-filled vibration damping device in accordance with the present invention, an operation for pressing the cylindrical member in the bottom member is not performed, and merely by performing assembling operation for lapping and fixing these members on and to each other, the second mounting member is constructed by an assembly of the cylindrical member and the bottom member, and also the air chamber is formed between the bottom member and the flexible diaphragm.

Therefore, the strict dimensional accuracy required for the conventional apparatus in which the second mounting member and the air chamber are formed by pressing one member in the other member corresponding to the cylindrical member and the bottom member is not required in the present invention. Moreover, if the cylindrical member and the bottom member are lapped on each other in the axial direction and are fixed to each other, a portion in which both of the members are lapped on each other in the direction perpendicular to the axis can be eliminated. Accordingly, as compared with the conventional apparatus, the length in the axial direction of the whole apparatus can be decreased very effectively.

Also, in the apparatus in accordance with the present invention, the volume of the air chamber decreases by the sum of an amount corresponding to the approach amount of the bottom member to the cylindrical member from the state in which either one of the cylindrical member and the bottom member is brought into contact with the tip end portion of the first seal protrusion to form the air chamber, the air therein being incapable of going in from the outside and going out to the outside, and an amount corresponding to the volume amount of the first seal protrusion entering into the air chamber, and thereby the internal pressure of the air chamber is increased. Therefore, for example, as compared with the conventional apparatus in which the volume of the air chamber decreases merely by only an amount corresponding to the press-in amount between the members corresponding to the cylindrical member and the bottom member, and thereby the internal pressure of the air chamber is increased, the internal pressure of the air chamber can be increased more efficiently and greatly.

Further, in the apparatus in accordance with the present invention, since the first seal protrusion is caused to fall to the inside of the air chamber in a compressedly deformed state by the lapping of the bottom member on the cylindrical member, when the internal pressure of the air chamber increases gradually with the approach of the bottom member to the cylindrical member, a phenomenon that the first seal protrusion is caused to fall on the opposite side to the air chamber by a pressing force applied so as to press the seal protrusion to the opposite side to the air chamber, and therefore air leaks from the falling portion to the outside can be inhibited advantageously. Thereby, too, the internal pressure of the air chamber can be increased sufficiently and surely.

In the above-described fluid-filled vibration damping device in accordance with the present invention, a structure capable of surely increasing the pressure of the non-compressible fluid filled in the pressure-receiving chamber and the equilibrium chamber by the air pressure in the air chamber and therefore capable of alleviating or preventing the occurrence of abnormal noise and vibrations caused by cavitation can be realized advantageously in a structure capable of improving the manufacturing ability and reducing the size of the whole apparatus.

The present invention can be carried out advantageously at least in various features as described below.

(1) A fluid-filled vibration damping device comprising: a first and a second mounting members which are spaced apart from each other; an elastic rubber body which elastically connects the first and second mounting members; a partition member supported by the second mounting member and cooperating with the elastic rubber body to define a pressure-receiving chamber which is filled with a non-compressible fluid and in which an internal pressure is changed by receiving an input vibrational load; a flexible diaphragm cooperating with the partition member to define an equilibrium chamber on one of the opposite sides of the partition member remote from the pressure-receiving chamber, the equilibrium chamber being filled with the fluid, and the flexible diaphragm being displaceable to permit a change in volume of the equilibrium chamber; an orifice passage provided to allow the pressure-receiving chamber and the equilibrium chamber to communicate with each other; and an air chamber filled with air with a pressure higher than an atmospheric pressure, and formed on the opposite side to the equilibrium chamber, so as to hold the flexible diaphragm between the air chamber and the equilibrium chamber, and an air pressure in the air chamber being applied to the fluid in the equilibrium chamber, whereby the pressure of the fluid may be increased, wherein the second mounting member comprises: a cylindrical member located at the first mounting member side, and having a cylindrical shape; and a bottom member located at the opposite side to the first mounting member, the bottom member being fixed to the cylindrical member and cooperating with the cylindrical member to support the partition member and the flexible diaphragm and forming the air chamber between the flexible diaphragm and the bottom member in a state of being lapped on an end portion of the cylindrical member so as to cover an opening on the opposite side to the first mounting member in the cylindrical member; and wherein the device further comprises: a seal member formed of an elastic material, the seal member being interposed between the lapped portions of the cylindrical member and the bottom member in a compressedly deformed state to seal the lapped portion in a fluid-tight manner; and a first seal protrusion formed by a part or a whole of the seal member, having a chevron shape, projecting in the direction such that the cylindrical member and the bottom member are lapped on each other, extending continuously in a circumferential direction so as to surround the air chamber, and being configured so that a cross-sectional shape has an inside surface facing to the air chamber and an outside surface opposite to the inside surface, and an internal angle of the inside surface being larger than the internal angle of the outside surface so that the first seal protrusion easily falls to the air chamber side at the time of compressed deformation caused by lapping of the bottom member on the cylindrical member; and wherein the seal member is interposed between the cylindrical member and the bottom member, either one of the cylindrical member and the bottom member is brought into contact with a tip end portion of the first seal protrusion, and from a state in which the air chamber, the air therein being incapable of going in from an outside and going out to the outside, is formed between the bottom member and the flexible diaphragm, the cylindrical member and the bottom member are brought close to each other and lapped on each other, and the first seal protrusion is caused to fall to an inside of the air chamber in a state of being compressedly deformed, whereby a volume of the air chamber is decreased, so that an internal pressure is increased.

(2) The fluid-filled vibration damping device according to the above feature (1), wherein the internal angle of the inside surface of the first seal protrusion is substantially set at a right angle or an obtuse angle. Thereby, the increase in internal pressure of the air chamber can be achieved more surely.

(3) The fluid-filled vibration damping device according to the above feature (1) or (2), wherein a housing portion having a concave portion or a hole for housing a portion of the first seal protrusion caused to fall to the air chamber side by compressed deformation is provided in an outer peripheral portion of the air chamber. Therefore, the increase in internal pressure of the air chamber can be achieved more advantageously, and thus the sealability can be improved more effectively.

(4) The fluid-filled vibration damping device according to any one of the above features (1)-(3), wherein a second seal protrusion formed of an elastic material is provided to project in the direction such that the cylindrical member and the bottom member are lapped on each other, to extend continuously in the circumferential direction so as to surround the first seal protrusion from the outside, and to have a cross-sectional shape parallel with the projecting direction so as not to fall easily at the time of compressed deformation caused by lapping of the bottom member on the cylindrical member. According to this feature, the air chamber has a double seal construction, and thus the sealability thereof is increased more advantageously. Moreover, since the second seal protrusion is not caused to fall in a compressedly deformed state unlike the first seal protrusion, a contact force per unit area with the cylindrical member and the bottom member can be enhanced more effectively than for the first seal protrusion. Thereby, the reliability in sealability can be increased more advantageously.

(5) The fluid-filled vibration damping device according to any one of above features (1)-(4), wherein the seal member formed of the elastic material is provided at an outer peripheral portion of the flexible diaphragm, the flexible diaphragm is supported on the second mounting member in a state in which the lapped portions are sealed by holding the seal member between the lapped portions of the cylindrical member and the bottom member, the seal member, and further the first seal protrusion is integrally formed on the seal member of the flexible diaphragm. According to this feature, as compared with the case where the seal member is provided apart from the flexible diaphragm, the number of parts can be reduced advantageously, which is helpful to achieve simplified construction of the whole apparatus and reduced size.

(6) The fluid-filled vibration damping device according to any one of the above features (1)-(4), wherein the bottom member consists of a one-side bottomed cylindrical body integrally having a cylindrical portion capable of being installed on the cylindrical member and a bottom portion that closes an opening on one side in the axial direction of the cylindrical portion, and the cylindrical portion is subjected to diameter-reducing operation in a state in which the cylindrical portion is installed on the cylindrical member and the bottom member is arranged so as to close an opening of the cylindrical member, whereby the bottom member is fixed in a state in which the bottom member is lapped on the cylindrical member, and the seal member is interposed between the cylindrical portion of the bottom member and the cylindrical member. According to this mode, the holding force between the bottom member and the cylindrical member is surely applied to the seal protrusion in the seal member due to the diameter-decreasing force to the cylindrical portion, and thereby the sealability of the air chamber is achieved throughout the entire periphery of the outer peripheral portion more surely and stably.

The above second object may be achieved by the following feature (7) of the present invention. (7) A seal structure for sealing an air chamber in a fluid-tight manner in a fluid-filled vibration damping device comprising: a first and a second mounting members which are spaced apart from each other; an elastic rubber body which elastically connects said first and second mounting members; a partition member supported by said second mounting member and cooperating with said elastic rubber body to define a pressure-receiving chamber which is filled with a non-compressible fluid and in which an internal pressure is changed by receiving an input vibrational load; a flexible diaphragm cooperating with said partition member to define an equilibrium chamber on one of the opposite sides of said partition member remote from said pressure-receiving chamber, said equilibrium chamber being filled with the fluid, and said flexible diaphragm being displaceable to permit a change in volume of said equilibrium chamber; an orifice passage provided to allow said pressure-receiving chamber and said equilibrium chamber to communicate with each other; and the air chamber filled with air with a pressure higher than an atmospheric pressure, formed on the opposite side to said equilibrium chamber, so as to hold said flexible diaphragm between said air chamber and said equilibrium chamber, and an air pressure in said air chamber being applied to said fluid in the equilibrium chamber, whereby the pressure of said fluid may be increased; wherein said second mounting member comprises a cylindrical portion formed on the second mounting member, the cylindrical portion having a cylindrical shape provided with a first opening that is open to the first mounting member side and a second opening that is open to the opposite side to the first mounting member, and supporting the partition member on the first mounting member side and supporting the flexible diaphragm on the opposite side to the first mounting member, and a closing member for closing the second opening of the cylindrical portion fixed to the cylindrical portion so as to be lapped on an end portion on the second opening side of the cylindrical portion, whereby the air chamber is formed between the closing member and the flexible diaphragm,

wherein a seal member formed of an elastic material is disposed to be interposed between the lapped portions of the cylindrical portion and the closing member in a compressedly deformed state to seal the lapped portion in a fluid-tight manner;

a seal protrusion having a chevron shape is formed by a part or a whole of the seal member, the seal protrusion projecting in the direction such that the cylindrical portion and the closing member are lapped on each other, extending continuously in a circumferential direction so as to surround the air chamber, and being configured so that a cross-sectional shape has an inside surface facing to the air chamber and an outside surface opposite to the inside surface, and an internal angle of the inside surface is larger than the internal angle of the outside surface so that the seal protrusion easily falls to the air chamber side at the time of compressed deformation caused by lapping of the closing member on the cylindrical portion; and

either one of the cylindrical portion and the closing member is brought into contact with a tip end portion of the seal protrusion in the seal member interposed between the cylindrical portion and the closing member, and from a state in which the air chamber, the air therein being incapable of going in from an outside and going out to the outside, is formed between the closing member and the flexible diaphragm, the cylindrical portion and the closing member are brought close to each other and lapped on each other, and the seal protrusion is caused to fall to an inside of the air chamber in a state of being compressedly deformed, whereby a volume of the air chamber is decreased, so that an internal pressure is increased to seal the air chamber in a fluid-tight manner in this state.

According to this feature, a high pressure of the non-compressible fluid filled in the pressure-receiving chamber and the equilibrium chamber caused by the air pressure in the air chamber can be realized very advantageously while the sealability of the air chamber is secured at a sufficiently high level in a structure in which the manufacturing ability can be improved and the size of the whole apparatus can be reduced. As a result, in a compact structure having high manufacturing ability, the occurrence of abnormal noise and vibrations caused by cavitation can be alleviated or prevented effectively.

### BRIEF DESCRIPTION OF THE DRAWINGS

The above and other objects, features, advantages and technical and industrial significance of the present invention will be better understood by reading the following detailed description of a presently preferred embodiment of the invention, when considered in connection with the accompanying drawings, in which:

FIG. 1 is a longitudinal section explanatory view showing one embodiment of a fluid-filled vibration damping device having a structure in accordance with the present invention;

FIG. 2 is a longitudinal section explanatory view showing a diaphragm mounted in the fluid-filled vibration damping device shown in FIG. 1;

FIG. 3 is a partially enlarged explanatory view of FIG. 2;

FIG. 4 is a view for explaining an example of one step for forming and sealing an air chamber in manufacturing the fluid-filled vibration damping device shown in FIG. 1, showing a state in which a partition member and a diaphragm are assembled to an integral vulcanized molded product formed by connecting a cylindrical member in a second mounting member to a first mounting member by means of an elastic rubber body to form a pressure-receiving chamber and an equilibrium chamber;

FIG. 5 is a view for explaining a step carried out following the step shown in FIG. 4, showing a state in which a bottom member is inserted in a staking portion of a cylindrical member to form an air chamber;

FIG. 6 is a view for explaining a step carried out following the step shown in FIG. 5, showing a state in which the insertion amount of bottom member is increased gradually with respect to a staking portion of a cylindrical member to gradually increase the internal pressure of an air chamber;

FIG. 7 is a view for explaining a step carried out following the step shown in FIG. 6, showing a state in which a bottom member is fixed by staking to a staking portion of a cylindrical member to seal an air chamber in such a manner that the internal pressure of the air chamber is higher than the atmospheric pressure;

FIG. 8 is a view for explaining an example of one step for forming and sealing an air chamber when another embodiment of a fluid-filled vibration damping device having a structure in accordance with the present invention, showing a state in which a bottom member is inserted onto the end portion of a cylindrical member to form the air chamber; and

FIG. 9 is a view for explaining a step carried out following the step shown in FIG. 8, showing a state in which a bottom member is fixed to a cylindrical member to seal an air chamber in such a manner that the internal pressure of the air chamber is higher than the atmospheric pressure.

### DETAILED DESCRIPTION OF THE PREFERRED EMBODIMENTS

Embodiments of the present invention will now be described in detail with reference to the accompanying drawings to clarify the present invention more specifically.

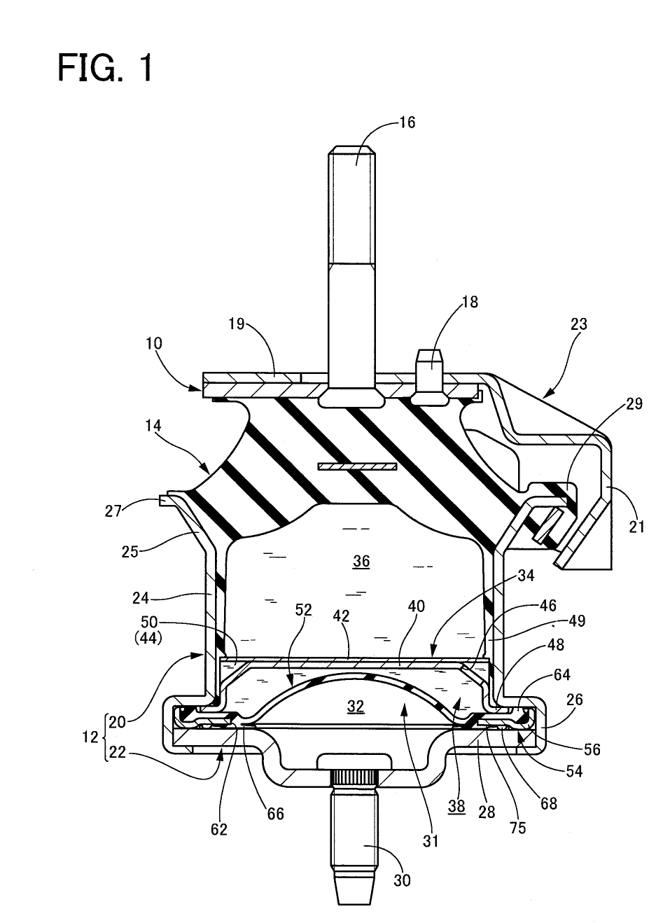

First, FIG. 1 schematically shows an automotive engine mount as one embodiment of a fluid-filled vibration damping device in accordance with the present invention by means of a longitudinal cross section mode. As is apparent from FIG. 1, the engine mount of this embodiment includes a first mounting member 10 serving as a first mounting member and a second mounting member 12 serving as a second mounting member. These first and second mounting members 10, 12 are spaced apart from each other in the up and down direction, and are connected elastically by an elastic rubber body 14. The first and second mounting members 10, 12 are attached to the power unit side and the vehicle body side, respectively, by which the power unit is supported on the vehicle body in such a manner that vibrations are isolated. When being mounted, the engine mount is subjected to a power unit load, and a main vibration load to be isolated is applied in the substantially opposing direction of the first and second mounting members 10, 12. In the following explanation, the up and down direction means the up and down direction in FIG. 1 in principle.

More specifically, the first mounting member 10 has a circular plate shape. In the central portion and the outer peripheral portion of the first mounting member 10, an attaching bolt 16 and a positioning pin 18 are integrally erected, respectively, so as to extend to a predetermined height toward the upside.

The second mounting member 12 has a substantially cylindrical shape, and is made up of a cylindrical member 20 having an opening open to the first mounting member 10 side (first opening) and an opening open to the opposite side thereto (second opening) and a substantially shallow bottomed cylindrical bottom member 22 that is open to the first mounting member 10 side. For the cylindrical member 20, the intermediate portion thereof in the height direction (axial direction) is a cylindrical portion 24, and the upper end portion thereof is a taper portion 25 the diameter of which increases toward the outside in the axial direction. At the tip end on the large-diameter side of the taper portion 25, an outer flange portion 27 is formed integrally. Further, the lower end portion is a staking portion 26. On the outer peripheral surface of the end portion on the opening side of the bottom member 22, a flange portion 28 having a wide-width ring plate shape is provided integrally. The flange portion 28 projects to a predetermined height in the radial direction and extends continuously in the circumferential direction.

The staking portion 26 of the cylindrical member 20 is fixed by staking to the flange portion 28 of the bottom member 22, by which the second mounting member 12 is formed so that the entire shape thereof is a substantially deep bottomed cylindrical shape. For the second mounting member 12 configured in this manner, in a substantially central portion of the bottom member 22, an attaching bolt 30 is erected so as to extend to a predetermined height toward the downside.

The elastic rubber body 14 connecting the first mounting member 10 to the second mounting member 12 substantially has a truncated cone shape. To the end surface on the small-diameter side of the elastic rubber body 14, the substantially whole lower surface of the first mounting member 10 is vulcanizedly bonded, and to the end surface on the large-diameter side thereof, the taper portion 25 of the cylindrical member 20 is vulcanizedly bonded. That is to say, the elastic rubber body 14 is formed as an integral vulcanized molded product having the first and the second mounting members 10, 12. Thereby, the first and second mounting members 10, 12 are connected elastically to each other by the elastic rubber body 14, and the opening of the second mounting member 12 is covered in a fluid-tight manner.

A stopper element 23 integrally having a disc-shaped mounting plate portion 19 and a stopper plate portion 21 extending slantwise downward from one place on the circumference of the mounting plate portion 19 is fixed to the first mounting member 10 in a state in which the mounting plate portion 19 is lapped on the first mounting member 10. In the stopper element 23, the stopper plate portion 21 is positioned so as to be separate a predetermined distance from a part of the outer flange portion 27 of the cylindrical member 20 of the second mounting member 12 and to cover the periphery of a part of the outer flange portion 27. In the portion of the outer flange portion 27, which portion is covered by the stopper plate portion 21, a stopper rubber portion 29 is formed integrally with the elastic rubber body 14 so as to surround the covered portion. Thus, when the first mounting member 10 is displaced greatly in the up and down direction, namely, in the separating/approaching direction with respect to the second mounting member 12 by the application of vibrations, the stopper rubber portion 29 provided in the outer flange portion 27 of the cylindrical member 20 of the second mounting member 12 is brought into contact with the stopper plate portion 21 of the stopper element 23, by which excessive displacement of the first mounting member 10 in the separating/approaching direction with respect to the second mounting member 12 can be inhibited.

In the engine mount of this embodiment, in the bottomed cylindrical second mounting member 12 the opening of which is covered by the elastic rubber body 14, a diaphragm 31 serving as a flexible diaphragm is housed. The diaphragm 31 is formed by a thin-wall disc shaped elastic rubber diaphragm, and is disposed so that the outer peripheral edge portion thereof is held by the staking portion of the cylindrical member 20 and the bottom member 22. Thereby, the interior of the second mounting member 12 is partitioned in a fluid-tight manner into the first mounting member 10 side and the bottom member 22 side by the diaphragm 31.

On the first mounting member 10 side of the diaphragm 31, a fluid chamber filled with a predetermined non-compressible fluid is formed, and on the opposite side to the fluid chamber of the diaphragm 31, an air chamber 32 that allows the diaphragm 31 to be deformed is formed. As the non-compressible fluid filled in the fluid chamber, water, alkylene glycol, polyalkylene glycol, silicone oil, and the like are used suitably.

In the fluid chamber formed as described above, a partition member 34 is housed, and is supported on the cylindrical member 20 of the second mounting member 12, so that the fluid chamber is divided into two chambers. Thereby, on the first mounting member 10 side of the partition member 34 in the fluid chamber, a pressure-receiving chamber 36 is formed which is configured so that a part of the wall portion thereof is formed by the elastic rubber body 14, and fluctuations in the internal pressure thereof are generated when vibrations are applied. On the opposite side to the pressure-receiving chamber 36 of the partition member 34, an equilibrium chamber 38 is formed, which is configured so that a part of the wall portion thereof is formed by the diaphragm 31, and a change in the volume thereof is allowed easily due to the deformation of the diaphragm 31.

The partition member 34 that partitions the interior of fluid chamber into the pressure-receiving chamber 36 and the equilibrium chamber 38 is formed by a lower element 40 substantially having a hat shape and a thin-wall disc shaped upper element 42 fixed to the upper surface of the lower element 40. In the partition member 34, the upper corner portion of the lower element 40 is recessed slantwise in a portion smaller than one round. Thereby, between the recessed portion of the lower element 40 and the upper element 42, a peripheral groove 44 is formed which is open to the side and extends with a length in the circumferential direction shorter than one round. The peripheral groove 44 is open to the upside in the end portion on the start point side through a communication hole (not shown) provided in the upper element 42, and is open to the downside in the end portion on the terminal point side through a communication hole 46 provided in the lower element 40. The partition member 34 is supported on the second mounting member 12 by being inserted in the cylindrical member 20 of the second mounting member 12 and by a flange portion 48 of the lower element 40 being held by the staking portion of the cylindrical member 20 and the bottom member 22.

The peripheral groove 44 of the partition member 34 is covered by the cylindrical member 20 via a seal rubber portion 49 formed on the inside of the cylindrical member 20 integrally with the elastic rubber body 14. The peripheral groove 44 is caused to communicate with the pressure-receiving chamber 36 through the communication hole, not shown, in the upper element 42, and is caused to communicate with the equilibrium chamber 38 through the communication hole 46 in the lower element 40. Thereby, an orifice passage 50 that causes the pressure-receiving chamber 36 and the equilibrium chamber 38 to communicate with each other by means of the peripheral groove 44 is formed.

In the engine mount of this embodiment, the orifice passage 50 is tuned to a low frequency region. Thereby, when low-frequency vibrations of, for example, engine shake is applied, an effective vibration control effect is achieved due to the resonance action of fluid caused to flow through the orifice passage 50.

In the engine mount of this embodiment, having the above-described construction, on the opposite side to the equilibrium chamber 38 of the diaphragm 31, the air chamber 32 provided between the diaphragm 31 and the bottom member 22 of the second mounting member 12 is sealed in a gastight manner by a special seal structure in which air is filled with a pressure higher than the atmospheric pressure, which provides a prominent feature.

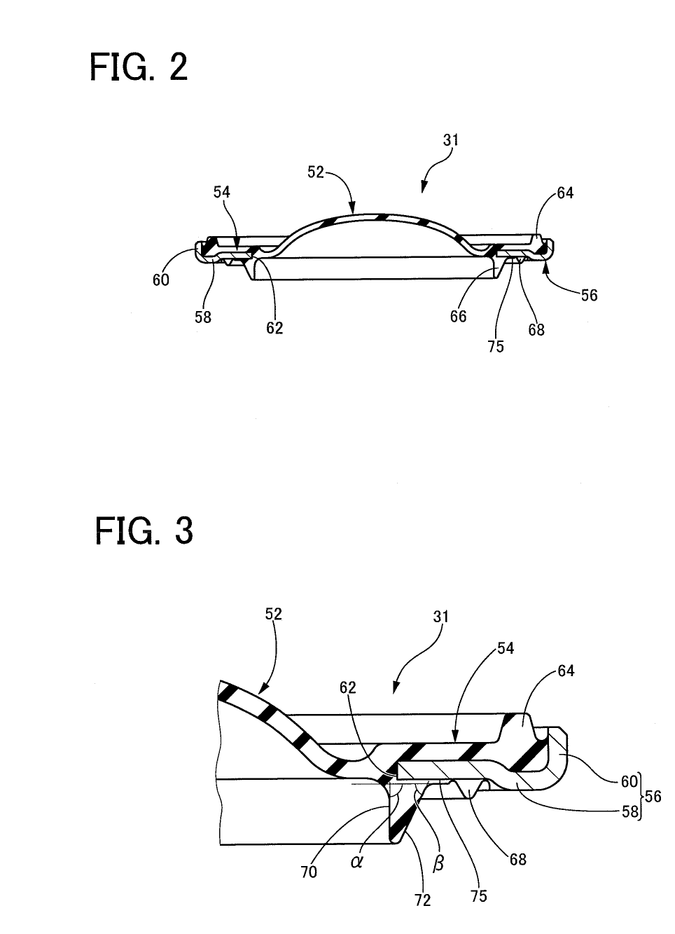

More specifically, as shown in FIG. 2, the center-side portion of the diaphragm 31 forming a part of the wall portion of the air chamber 32 is a deflection deformation portion 52 that has a small thickness and substantially has a dome shape, and is easily deflected and deformed, and the outer peripheral portion thereof is a seal member 54 that has a large thickness and a ring shape.

In the seal member 54, a holding element 56 is embedded. The holding element 56 has a substantially shallow bottomed cylindrical entire shape provided integrally with a disc-shaped bottom portion 58 and a short cylindrical portion 60. In the bottom portion 58, a large-diameter circular center hole 62 is formed in the central portion thereof, and the lower surface of the outer peripheral portion thereof is exposed to the outside. In the cylindrical portion 60 as well, the whole of the outer peripheral surface thereof is exposed to the outside.

In the above-described seal member 54, an upper seal protrusion 64 having a trapezoidal longitudinal cross-sectional shape is projectingly formed integrally in the outer peripheral edge of the upper surface of the seal member 54, the upper seal protrusion 64 having a ring-shaped protrusion extending continuously in the circumferential direction. The tip end portion of the upper seal protrusion 64 is projectingly positioned higher than the tip end surface of the cylindrical portion 60 of the holding element 56.

On the lower surface of the seal member 54, a lower first seal protrusion 66 is projectingly provided integrally in the inner peripheral portion thereof, the lower first seal protrusion 66 having a ring-shaped protrusion extending continuously in the circumferential direction. The substantially half portion on the inside of the lower first seal protrusion 66 is positioned on the inside of the center hole 62 in the bottom portion 58 of the holding element 56 in the seal member 54. In the outer peripheral portion of the lower surface of the seal member 54, a lower second seal protrusion 68 having a ring-shaped protrusion is projectingly formed integrally at a position separating a predetermined distance in the radial direction from the lower first seal protrusion 66 so as to surround the lower first seal protrusion 66 from the outside, the lower second seal protrusion 68 being configured so as to have a height smaller than the that of lower first seal protrusion 66 and extend continuously in the circumferential direction.

Of the two seal protrusions 66 and 68, the lower first seal protrusion 66 has a triangular chevron-shaped longitudinal cross section having a height significantly larger than that of the general seal protrusion formed in the conventional engine mount. In the lower first seal protrusion 66, the internal angle α of an inside surface 70 is larger than the internal angle β of an outside surface 72. In this embodiment, in particular, the internal angle α of the inside surface 70 is set at approximately 90° or an angle slightly larger than 90°, namely, substantially at the right angle or an obtuse angle. Thereby, when a pressing force is applied from the tip end side toward the proximal portion side, the lower first seal protrusion 66 is easily caused to fall toward the inside while being compressedly deformed.

The lower second seal protrusion 68 has a substantially isosceles triangular chevron-shaped longitudinal cross section having almost the same height as that of the general seal protrusion formed in the conventional engine mount and having an inside surface and an outside surface tilting with almost the same gradient. Thereby, when a pressing force is applied from the tip end side toward the proximal portion side, the lower second seal protrusion 68 is not caused to fall easily, and is compressedly (collapsedly) deformed substantially straight in the height direction.

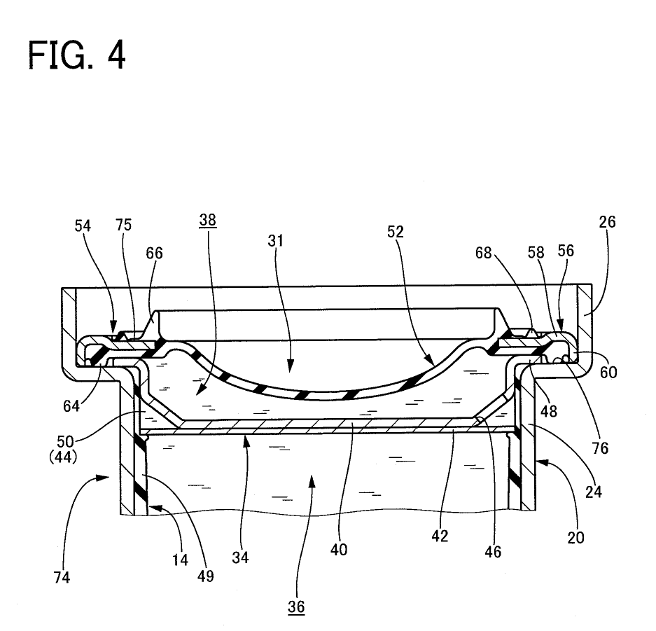

In the engine mount of this embodiment, at the time of manufacture thereof, for example, as shown in FIG. 4, the partition member 34 and the diaphragm 31 are assembled to an integral vulcanized molded product 74 in which the first mounting member 10 and the cylindrical member 20 of the second mounting member 12 are vulcanizedly bonded to the elastic rubber body 14.

The assembling operation of the partition member 34 and the diaphragm 31 to the integral vulcanized molded product 74 is performed in a turned-over state in the non-compressible fluid stored in a predetermined storage vessel in the same way as the conventional example. Specifically, in the non-compressible fluid, first, the partition member 34 is inserted to a position at which a flange portion 48 of the lower element 40 is brought into contact with a step surface 76 provided in the staking portion 26 of the cylindrical member 20. The upper seal protrusion 64 of the seal member 54 is brought into contact with the step surface 76 of the staking portion 26, and then the diaphragm 31 is pressed in, while being compressedly deformed, to a position at which the tip end surface of the cylindrical portion 60 comes into contact with the step surface 76.

Thereby, the staking portion 26 of the cylindrical member 20 is sealed in a fluid-tight manner by the upper seal protrusion 64 in the seal member 54 of the diaphragm 31. A non-compressible fluid is filled between the diaphragm 31 and the first mounting member 10, and the pressure-receiving chamber 36 is formed on the first mounting member 10 side of the partition member 34. The equilibrium chamber 38 is formed on the opposite side to the pressure-receiving chamber 36.

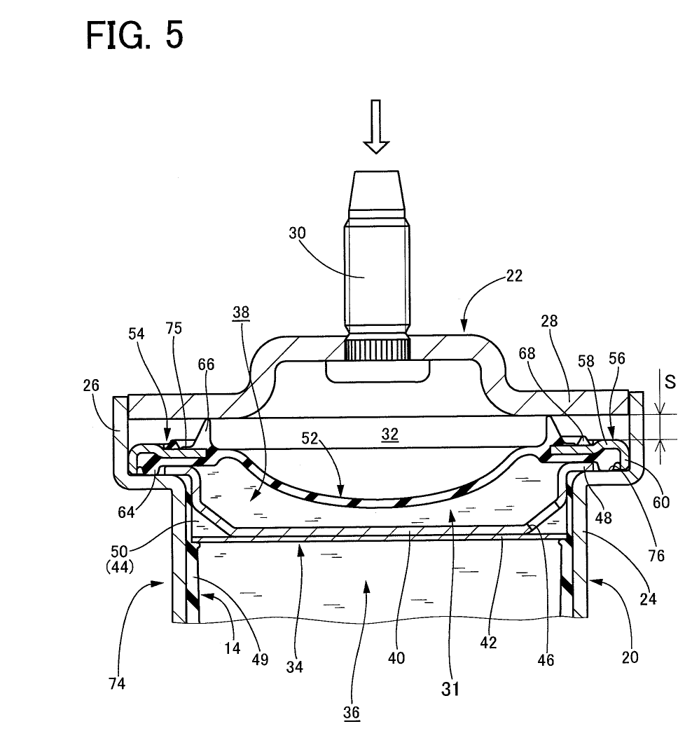

After the integral vulcanized molded product 74 to which the partition member 34 and the diaphragm 31 have been assembled has been removed from the non-compressible fluid, as shown in FIG. 5, the bottom member 22 is inserted into the staking portion 26 of the cylindrical member 20, and the bottom member 22 and the cylindrical member 20 are gradually brought close to each other. The flange portion 28 of the bottom member 22 is contactingly positioned at the tip end of the lower first seal protrusion 66 of the seal member 54 of the diaphragm 31 pressed in the staking portion 26 of the cylindrical member 20, by which the air chamber 32, the air therein being incapable of going in from the outside and going out to the outside, is formed between the bottom member 22 and the diaphragm 31. The operation for inserting the bottom member 22 into the staking portion 26 of the cylindrical member 20 and further a series of successive operations are carried out in the state in which the integral vulcanized molded product 74 is turned over until the engine mount is completed.

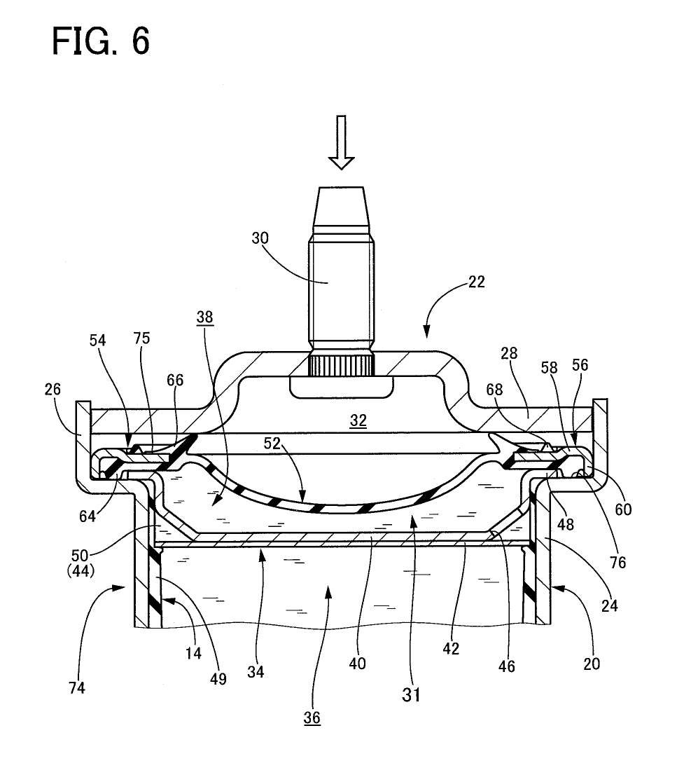

Subsequently, as shown in FIG. 6, as the insertion amount of the bottom member 22 into the staking portion 26 of the cylindrical member 20, in other words, the approach amount of the bottom member 22 to the cylindrical member 20 increases, the volume of the air chamber 32 decreases gradually by an amount corresponding to the approach amount. With the decrease in volume of the air chamber 32, the internal pressure of the air chamber 32 increases gradually.

When the insertion amount of the bottom member 22 into the staking portion 26 of the cylindrical member 20 increases gradually, the lower first seal protrusion 66 is pressed from the tip end side toward the proximal portion side by the flange portion 28 of the bottom member 22, and is compressedly deformed gradually. At this time, since the lower first seal protrusion 66 is configured so as to be capable of being caused to fall easily toward the inside as described above in the process of being compressedly deformed by the pressing force from the tip end side to the proximal portion side, the lower first seal protrusion 66 is gradually caused to fall to the inside, and enters into the air chamber 32. Such entrance of the lower first seal protrusion 66 into the air chamber 32 decreases the volume of the air chamber 32 further by an amount corresponding to the volume amount of the lower first seal protrusion 66 entering into the air chamber 32, whereby the internal pressure of the air chamber 32 is further increased.

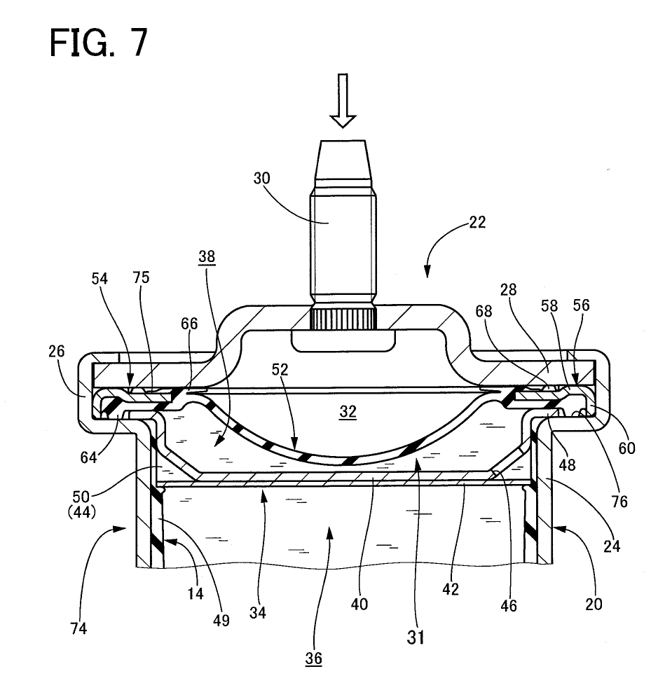

As shown in FIG. 7, after the flange portion 28 of the bottom member 22 has been brought into contact with the outer peripheral portion of the bottom portion 58 of the holding element 56 in the diaphragm 31 by the insertion of the bottom member 22 into the staking portion 26 of the cylindrical member 20, the publicly known staking operation is performed on the staking portion 26 of the cylindrical member 20, by which the bottom member 22 is fixed to the cylindrical member 20. Between these elements 22 and 20, the seal member 54 of the diaphragm 31 and the flange portion 48 of the lower element 40 of the partition member 34 are held under pressure. Therefore, the diaphragm 31 and the partition member 34 are fixed to the second mounting member 12 consisting of the bottom member 22 and the cylindrical member 20.

Under such a condition, the lower first seal protrusion 66 is brought into close contact with the inner peripheral portion of the flange portion 28 of the bottom member 22 in the state of falling completely to the air chamber 32 side while being compressedly deformed and entering into the air chamber 32. Thereby, as is apparent from FIGS. 5 and 7, the volume of the air chamber 32 decreases by the sum of an amount corresponding to the insertion stroke (the dimension denoted by S in FIG. 5) of the bottom member 22 into the staking portion 26 of the cylindrical member 20 and an amount corresponding to the volume amount of entrance into the air chamber 32 caused by the falling of the seal member 54 in the diaphragm 31.

At this time, most of the portion of the lower first seal protrusion 66, which portion falls to the inside of the air chamber 32 and enters into the air chamber 32, is housed in the outer peripheral portion in the center hole 62 of the holding element 56. A portion held in a compressed state between the bottom portion 58 of the holding element 56 and the bottom member 22 decreases as far as possible. Therefore, by the existence of such a held portion, the decrease in insertion stroke of the bottom member 22 into the staking portion 26 of the cylindrical member 20 can be avoided advantageously. As is apparent from this fact, a housing portion for housing the portion of seal protrusion entering into the air chamber is formed by the center hole 62 in the bottom portion 58 in the holding element 56.

The lower second seal protrusion 68 provided in the seal member 54 so as to surround the lower first seal protrusion 66 from the outside is also brought into close contact with the flange portion 28 of the bottom member 22 in a compressedly deformed state. As described above, the lower second seal protrusion 68 is not caused to fall easily, and is compressedly deformed substantially straight in the height direction. In the lower second seal protrusion 68, in the compressedly deformed state, the contact area with the flange portion 28 of the bottom member 22 is significantly smaller than that of the lower first seal protrusion 66. A reaction force per unit area applied to the flange portion 28, in other words, a pressing force to the flange portion 28 is surely made higher than that of the lower first seal protrusion 66.

In the inner peripheral portion of the bottom portion 58 of the holding element 56, a concave portion 75 depressed toward the tip end side of the cylindrical portion 60 is provided, and the lower second seal protrusion 68 is housed in the concave portion 75 in a compressedly deformed state. By the existence of the lower second seal protrusion 68 between the bottom portion 58 of the holding element 56 and the bottom member 22 in the compressedly deformed state, the decrease in insertion stroke of the bottom member 22 into the staking portion 26 of the cylindrical member 20 can be avoided advantageously.

In the engine mount of this embodiment, the air pressure in the air chamber 32 is higher than the atmospheric pressure by a predetermined amount, and the air chamber 32 is sealed in a gastight manner by the lower first seal protrusion 66 and the lower second seal protrusion 68 in the seal member 54 of the diaphragm 31. By the air pressure in the air chamber 32 higher than the atmospheric pressure, the deflection deformation portion 52 of the diaphragm 31 is expanded toward the equilibrium chamber 38 side, so that an air pressure higher than the atmospheric pressure is applied to the non-compressible fluid in the equilibrium chamber 38 and the pressure-receiving chamber 36. The pressure of non-compressible fluid in the equilibrium chamber 38 and the pressure-receiving chamber 36 is increased. As is apparent from this fact, a cylindrical portion is formed by the cylindrical member 20, and a closing member is formed by the bottom member 22.

In the engine mount of this embodiment, in the state in which the diaphragm 31 is pressedly fixed in the staking portion 26 of the cylindrical member 20 as in the conventional example, merely by inserting the bottom member 22 into the staking portion 26 and performing staking operation on the staking portion 26, the internal pressure of the air chamber 32 is made higher than the atmospheric pressure, and hence the air chamber 32 can be sealed.

In the above-described engine mount, strict dimensional accuracy is not required for the inside diameter dimension of the bottom member 22 and the outside diameter dimension of the cylindrical member 20 unlike the conventional apparatus in which, for example, by pressing the bottom member 22 in the cylindrical member 20 via a predetermined seal member, the internal pressure of the air chamber 32 is made high to seal the air chamber 32, and thereby the manufacturing ability can be improved advantageously.

Moreover, in the above-described engine mount, the bottom member 22 is not pressed in the cylindrical member 20, and all of the seal protrusions 64, 66 and 68 of the seal member 54 are compressedly deformed in the up and down direction, by which the sealability can be secured. The pressing allowance and sealing allowance extending in the up and down direction can be reduced or eliminated effectively, and the height of the whole apparatus can be decreased. As a result, the size of apparatus can be reduced advantageously.

In this embodiment, the volume of the air chamber 32 decreases by the sum of the amount corresponding to the insertion amount of the bottom member 22 into the cylindrical member 20 (the approach amount of both of the elements 20 and 22) and the amount corresponding to the volume amount of the lower first seal protrusion 66 entering into the air chamber 32 due to the falling caused by the insertion of the bottom member 22 in the cylindrical member 20, and thereby the internal pressure of the air chamber 32 is increased. Therefore, for example, as compared with the conventional apparatus in which the volume of the air chamber 32 decreases merely by only an amount corresponding to the insertion amount of the bottom member 22 into the cylindrical member 20, and thereby the internal pressure of the air chamber 32 is increased, the internal pressure of the air chamber 32 can be increased efficiently and surely.

In the engine mount of this embodiment, by the insertion of the bottom member 22 into the cylindrical member 20, the lower first seal protrusion 66 is caused to fall to the inside of the air chamber 32. By the rise in internal pressure of the air chamber 32 caused by the increase in insertion amount of the bottom member 22 into the cylindrical member 20, the lower first seal protrusion 66 is caused to fall to the outside of the air chamber 32 by a working force that presses the lower first seal protrusion 66 to the outside of the air chamber 32, so that the leakage of air to the outside can be inhibited effectively. Thereby, too, the internal pressure of the air chamber 32 can be increased more stably and surely.

In the above-described engine mount, most of the portion of the lower first seal protrusion 66, which portion falls to the inside of the air chamber 32 and enters into the air chamber 32, is housed in the center hole 62 of the bottom portion 58 in the holding element 56, by which the decrease in insertion stroke of the bottom member 22 into the staking portion 26 of the cylindrical member 20 can be avoided advantageously. The internal pressure of the air chamber 32 can be increased more efficiently and surely.

In the above-described engine mount, in the state in which the air chamber 32 having an internal pressure higher than the atmospheric pressure is formed, the lower second seal protrusion 68 provided in the outer peripheral portion of the seal member 54 so as to surround the lower first seal protrusion 66 is brought into close contact with the bottom member 22 by a pressing force greater than that of the lower first seal protrusion 66. The reliability of sealing of the air chamber 32 can be increased effectively.

In the engine mount of this embodiment configured as described above, a structure capable of surely increasing the pressure of the non-compressible fluid filled in the pressure-receiving chamber 36 and the equilibrium chamber 38 by the air pressure in the air chamber 32 can be realized advantageously in a structure capable of improving the manufacturing ability and reducing the size of the whole apparatus. The occurrence of abnormal noise and vibrations caused by cavitation can be alleviated or prevented very advantageously.

In this embodiment, since the seal member 54 for sealing the air chamber 32 is formed by the outer peripheral portion of the diaphragm 31, a simplified construction and a reduced size can be achieved advantageously as compared with the case where the seal member 54 is formed by a member separate from the diaphragm 31.

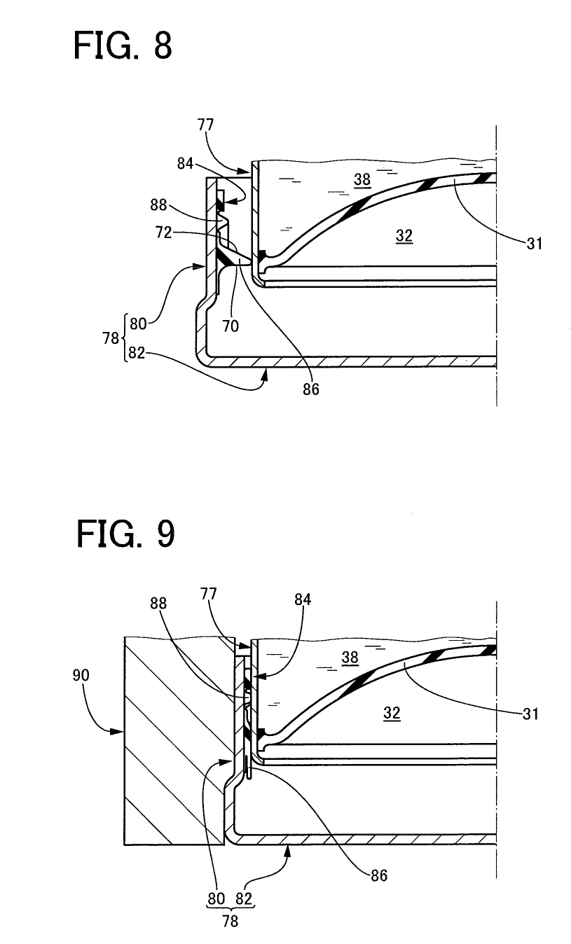

The seal structure of the air chamber is not limited to the structure shown in the above-described embodiment, and the air chamber can be sealed as shown in FIGS. 8 and 9. In the embodiment shown in FIGS. 8 and 9, the same reference numerals as those in FIGS. 1 to 7 are applied to members and portions having the same structure as that of the aforementioned embodiment, and the detailed explanation is omitted.

In this embodiment, the second mounting member is formed by only a cylindrical member 77 that is open to the side of the first mounting member (not shown) serving as the first mounting member (upper side) and the opposite side thereto (lower side). That is to say, the whole of the second mounting member is a cylindrical portion, and also, for example, a publicly known bracket etc. are attached to the cylindrical member 77 so that the cylindrical member 77 is attached to, for example, the vehicle body side. In the cylindrical member 77, the partition member (not shown) and the diaphragm 31 are positioned separately in the up and down direction and are supported, and a non-compressible fluid is filled. Thereby, the pressure-receiving chamber is formed on the first mounting member side of the partition member, and the equilibrium chamber 38 is formed on the opposite side to the pressure-receiving chamber.

In the engine mount of this embodiment, in manufacturing, as shown in FIG. 8, in the end portion on the opposite side to the first mounting member side in the cylindrical member 77, namely, in the end portion on the side on which the diaphragm 31 is supported, a bottom member 78 having a bottomed cylindrical shape, serving as a closing member, is installed on the outside of the cylindrical member 77.

The bottom member 78 integrally has a cylindrical portion 80 having a predetermined diameter dimension larger than the diameter of the cylindrical member 77 and a bottom portion 82 that closes the opening on one side of the cylindrical portion 80. On the inner peripheral surface of the cylindrical portion 80, a seal member 84 consisting of a thin-wall cylindrical elastic rubber body is fixed so as to extend continuously in the circumferential direction. On the inner peripheral surface of the seal member 84, a first seal protrusion 86 and a second seal protrusion 88 are projectingly provided integrally on the lower side and the upper side, respectively.

The first seal protrusion 86 has almost the same construction as that of the lower first seal protrusion 66 in the aforementioned embodiment, and is configured so as to be capable of being caused to fall to the downside easily when a pressing force is applied in the height direction. Specifically, the internal angle of the inside surface 70 is larger than the internal angle of the outside surface 72. Herein, the internal angle of the inside surface 70 is substantially set at the right angle or an obtuse angle, and the internal angle of the outside surface 72 is set at an acute angle. The second seal protrusion 88 has almost the same construction as that of the lower second seal protrusion 68 in the aforementioned embodiment, and is configured so as to be not caused to fall easily and collapsedly deformed straight when a pressing force is applied in the height direction.

In the state in which the bottom member 78 is installed on the outside of the support-side end portion of the diaphragm 31 in the cylindrical member 77 as described above, the outer peripheral surface of the cylindrical member 77 is brought into contact with the tip end portion of the first seal protrusion 86 in the seal member 84, by which the air chamber 32, the air therein being incapable of going in from the outside and going out to the outside, is formed between the diaphragm 31 and the bottom member 78. At this time, the inside surface 70 of the first seal protrusion 86 is positioned on the lower side so that the first seal protrusion 86 can be caused to fall easily to the air chamber 32 side (lower side) at the time of compressed deformation. The second seal protrusion 88 is positioned so as to surround the periphery of the first seal protrusion 86 from the outside (upper side).

Next, as shown in FIG. 9, diameter-reducing operation such as all-direction drawing is accomplished on the cylindrical portion 80 of the bottom member 78 by using a publicly known drawing die 90, by which the bottom member 78 is fixed to the cylindrical member 77 in the diameter-decreased cylindrical portion 80. At this time, as the drawing amount of the cylindrical portion 80, namely, the approach amount of the cylindrical portion 80 to the cylindrical member 77 increases, the volume of the air chamber 32 decreases gradually by an amount corresponding to the approach amount. With the decrease in volume of the air chamber 32, the internal pressure of the air chamber 32 increases gradually.

When the approach amount of the cylindrical portion 80 to the cylindrical member 77 increases gradually, the first seal protrusion 86 is pressed by the outer peripheral surface of the cylindrical member 77, and is caused to fall gradually to the inside of the air chamber 32, entering into the air chamber 32. Such entrance of the first seal protrusion 86 into the air chamber 32 also decreases the volume of the air chamber 32 further by an amount corresponding to the volume amount of the first seal protrusion 86 entering into the air chamber 32, whereby the internal pressure of the air chamber 32 is further increased. Further, the second seal protrusion 88 is interposed between the outer peripheral surface of the cylindrical member 77 and the cylindrical portion 80 of the bottom member 78 in a compressedly deformed state.

Thus, in the engine mount of this embodiment, an operation for pressing the bottom member 78 in the cylindrical member 77 is not performed, and merely by installing the cylindrical portion 80 of the bottom member 78 on the outside of the support-side end portion of the diaphragm 31 in the cylindrical member 77 and by subjecting the cylindrical portion 80 of the bottom member 78 to diameter-reducing operation to lap the bottom member 78 and the cylindrical member 77 on each other in the radial direction, the internal pressure of the air chamber 32 is made higher than the atmospheric pressure, by which the air chamber 32 can be sealed.

In the above-described engine mount of this embodiment as well, the operation and effects achieved in the aforementioned first embodiment can be brought about advantageously.

In the above-described engine mount, in particular, the holding force between the cylindrical portion 80 of the bottom member 78 and the cylindrical member 77 is surely applied to the first seal protrusion 86 in the seal member 84 throughout the entire periphery due to a diameter-decreasing force to the cylindrical portion 80. Thereby, this embodiment has an advantage that the sealability of the air chamber 32 can be achieved more surely and stably around the circumference of the outer peripheral portion of the air chamber 32.

The above is a detailed description of the embodiments of the present invention. These embodiments merely show examples, and therefore the present invention is not restricted by the concrete description of the embodiments.

For example, in the first embodiment, the bottom member 22 is inserted into the staking portion 26 of the cylindrical member 20. However, in place of this inserting operation, a pressing-in operation may be performed. In this case as well, regardless of the pressing-in amount of the bottom member 22 to the cylindrical member 20, the volume of the air chamber 32 decreases by an amount corresponding to the height and volume of the lower first seal protrusion 66 that is caused to fall, by which the internal pressure is increased. Therefore, the advantages gained by the first embodiment, such as decreased size, can be enjoyed advantageously.

Also, even in the case where the second mounting member is formed by the cylindrical member 20 and the bottom member 22, the cylindrical member 20 and the bottom member 22 can be fixed to each other by subjecting the cylindrical member 20 to diameter-reducing operation such as publicly known drawing in place of the operation for staking the cylindrical member 20.

Regarding the internal angle α of the inside surface 70 and the internal angle β of the outside surface 72 of the first seal protrusion 66, 86, if the former is substantially set at the right angle or an obtuse angle and the latter is set at an acute angle, the specific magnitude of angle is not subject to any restriction.

In the first embodiment, the seal member 54 is provided in the outer peripheral portion of the diaphragm 31, and the lower first seal protrusion 66, which is the first seal protrusion, is provided integrally in the seal member 54. However, the first seal protrusion may be provided at least either one of lapped portions of the cylindrical member 20 and the bottom member 22 apart from the diaphragm 31.

In the first embodiment, the housing portion is formed in the center hole 62 of the holding element 56 embedded in the seal member 54 of the diaphragm 31. However, for example, in place of or in addition to this configuration, a concave portion capable of housing the lower first seal protrusion 66 as the seal protrusion (first seal protrusion), caused to fall in a compressedly deformed state, may be formed in the inner peripheral portion of the holding element 56, and the housing portion may be formed in this concave portion.

In the second embodiment, the first seal protrusion 86 is provided on the bottom member 78. However, in place of or in addition to this configuration, the first seal protrusion 86 may be provided on the cylindrical member 77.

It is a matter of course that the construction of the partition member or the forming construction, number, position, etc. of orifice passage are also not limited to those shown as an example.

In addition, in the above-described embodiments, a specific example in which the present invention is applied to an automotive engine mount has been shown. However, needless to say, the present invention can be applied advantageously to a fluid-filled vibration damping device used for an automotive body mount and various pieces of equipment other than the motor vehicle.

Besides, though not cited in detail, the present invention can be carried out in any mode in which various changes, modifications, and improvement are made based on the knowledge of the person skilled in the art. It is a matter of course that all of such modes are embraced in the scope of the present invention unless departing from the teachings of the present invention.

What is claimed is:

1. A fluid-filled vibration damping device comprising:
a first and a second mounting members which are spaced apart from each other;
an elastic rubber body which elastically connects said first and second mounting members;
a partition member supported by said second mounting member and cooperating with said elastic rubber body to define a pressure-receiving chamber which is filled with a non-compressible fluid and in which an internal pressure is changed by receiving an input vibrational load;
a flexible diaphragm cooperating with said partition member to define an equilibrium chamber on one of the opposite sides of said partition member remote from said pressure-receiving chamber, said equilibrium chamber being filled with the fluid, and said flexible diaphragm being displaceable to permit a change in volume of said equilibrium chamber;
an orifice passage provided to allow said pressure-receiving chamber and said equilibrium chamber to communicate with each other; and
an air chamber filled with air with a pressure higher than an atmospheric pressure, and formed on the opposite side to said equilibrium chamber, so as to hold said flexible diaphragm between said air chamber and said equilibrium chamber, and an air pressure in said air chamber being applied to said fluid in the equilibrium chamber, whereby the pressure of said fluid may be increased,
wherein said second mounting member comprises:
a cylindrical member located at said first mounting member side, and having a cylindrical shape; and
a bottom member located at the opposite side to said first mounting member, the bottom member being fixed to said cylindrical member and cooperating with said cylindrical member to support said partition member and said flexible diaphragm and forming said air chamber between said flexible diaphragm and said bottom member in a state of being lapped on an end portion of said cylindrical member so as to cover an opening on the opposite side to said first mounting member in said cylindrical member; and
wherein said device further comprises:
a seal member formed of an elastic material, the seal member being interposed between the lapped portions of said cylindrical member and said bottom member in a compressedly deformed state to seal the lapped portion in a fluid-tight manner; and
a first seal protrusion formed by a part or a whole of said seal member, having a chevron shape, projecting in the direction such that said cylindrical member and said bottom member are lapped on each other, extending continuously in a circumferential direction so as to surround said air chamber, and being configured so that a cross-sectional shape has an inside surface facing to said air chamber and an outside surface opposite to the inside surface, and an internal angle of the inside surface being larger than the internal angle of the outside surface so that said first seal protrusion easily falls to said air chamber side at the time of compressed deformation caused by lapping of said bottom member on said cylindrical member; and
wherein said seal member is interposed between said cylindrical member and said bottom member, either one of said cylindrical member and said bottom member is brought into contact with a tip end portion of said first seal protrusion, and from a state in which said air chamber, the air therein being incapable of going in from an outside and going out to the outside, is formed between the bottom member and the flexible diaphragm, the cylindrical member and the bottom member are brought close to each other and lapped on each other, and said first seal protrusion is caused to fall to an inside of said air chamber in a state of being compressedly deformed, whereby a volume of said air chamber is decreased, so that an internal pressure is increased.

2. The fluid-filled vibration damping device according to claim 1,
wherein said internal angle of the inside surface of said first seal protrusion is substantially set at a right angle or an obtuse angle.

3. The fluid-filled vibration damping device according to claim 1,
wherein a housing portion having a concave portion or a hole for housing a portion of said first seal protrusion caused to fall to the air chamber side by compressed deformation is provided in an outer peripheral portion of said air chamber.

4. The fluid-filled vibration damping device according to claim 1,
wherein a second seal protrusion formed of an elastic material is provided to project in the direction such that said cylindrical member and said bottom member are lapped on each other, to extend continuously in the circumferential direction so as to surround said first seal protrusion from the outside, and to have a cross-sectional shape parallel with the projecting direction so as not to fall easily at the time of compressed deformation caused by lapping of said bottom member on said cylindrical member.

5. The fluid-filled vibration damping device according to claim 1,
wherein said seal member formed of the elastic material is provided at an outer peripheral portion of said flexible diaphragm, said flexible diaphragm is supported on said second mounting member in a state in which the lapped portions are sealed by holding said seal member between the lapped portions of said cylindrical member and said bottom member, said seal member, and further said first seal protrusion is integrally formed on the seal member of the flexible diaphragm.

6. The fluid-filled vibration damping device according to claim 1,
wherein said bottom member consists of a one-side bottomed cylindrical body integrally having a cylindrical portion capable of being installed on said cylindrical member and a bottom portion that closes an opening on one side in the axial direction of the cylindrical portion, and said cylindrical portion is subjected to diameter-reducing operation in a state in which said cylindrical portion is installed on said cylindrical member and said bottom member is arranged so as to close an opening of said cylindrical member, whereby said bottom member is fixed in a state in which said bottom member is lapped on said cylindrical member, and said seal member is interposed between the cylindrical portion of the bottom member and the cylindrical member.

7. A seal structure for sealing an air chamber in a fluid-tight manner in a fluid-filled vibration damping device comprising: a first and a second mounting members which are spaced apart from each other; an elastic rubber body which elastically connects said first and second mounting members; a partition member supported by said second mounting member and cooperating with said elastic rubber body to define a pressure-receiving chamber which is filled with a non-compressible fluid and in which an internal pressure is changed by receiving an input vibrational load; a flexible diaphragm cooperating with said partition member to define an equilibrium chamber on one of the opposite sides of said partition member remote from said pressure-receiving chamber, said equilibrium chamber being filled with the fluid, and said flexible diaphragm being displaceable to permit a change in volume of said equilibrium chamber; an orifice passage provided to allow said pressure-receiving chamber and said equilibrium chamber to communicate with each other; and the air chamber filled with air with a pressure higher than an atmospheric pressure, formed on the opposite side to said equilibrium chamber, so as to hold said flexible diaphragm between said air chamber and said equilibrium chamber, and an air pressure in said air chamber being applied to said fluid in the equilibrium chamber, whereby the pressure of said fluid may be increased; wherein said second mounting member comprises a cylindrical portion formed on the second mounting member, the cylindrical portion having a cylindrical shape provided with a first opening that is open to the first mounting member side and a second opening that is open to the opposite side to the first mounting member, and supporting the partition member on the first mounting member side and supporting the flexible diaphragm on the opposite side to the first mounting member, and a closing member for closing the second opening of the cylindrical portion fixed to the cylindrical portion so as to be lapped on an end portion on the second opening side of the cylindrical portion, whereby the air chamber is formed between the closing member and the flexible diaphragm,
wherein a seal member formed of an elastic material is disposed to be interposed between the lapped portions of the cylindrical portion and the closing member in a compressedly deformed state to seal the lapped portion in a fluid-tight manner;
a seal protrusion having a chevron shape is formed by a part or a whole of the seal member, the seal protrusion projecting in the direction such that the cylindrical portion and the closing member are lapped on each other, extending continuously in a circumferential direction so as to surround the air chamber, and being configured so that a cross-sectional shape has an inside surface facing to the air chamber and an outside surface opposite to the inside surface, and an internal angle of the inside surface is larger than the internal angle of the outside surface so that the seal protrusion easily falls to the air chamber side at the time of compressed deformation caused by lapping of the closing member on the cylindrical portion; and
either one of the cylindrical portion and the closing member is brought into contact with a tip end portion of the seal protrusion in the seal member interposed between the cylindrical portion and the closing member, and from a state in which the air chamber, the air therein being incapable of going in from an outside and going out to the outside, is formed between the closing member and the flexible diaphragm, the cylindrical portion and the closing member are brought close to each other and lapped on each other, and the seal protrusion is caused to fall to an inside of the air chamber in a state of being compressedly deformed, whereby a volume of the air chamber is decreased, so that an internal pressure is increased to seal the air chamber in a fluid-tight manner in this state.
